(19) United States
(12) Patent Application Publication
(10) Pub. No.: US 2024/0408660 A1
(43) Pub. Date: Dec. 12, 2024

(54) PRESS DEVICE AND METHOD OF PRESSING

(71) Applicant: TOYOTA BOSHOKU KABUSHIKI KAISHA, Aichi (JP)

(72) Inventors: Yuki KIMURA, Inuyama-shi (JP); Jotaro KATO, Tokai-shi (JP); Toshinari OKAMOTO, Okazaki-shi (JP)

(73) Assignee: TOYOTA BOSHOKU KABUSHIKI KAISHA, Aichi (JP)

(21) Appl. No.: 18/734,050

(22) Filed: Jun. 5, 2024

(30) Foreign Application Priority Data
Jun. 12, 2023 (JP) 2023-096249

(51) Int. Cl. B21D 5/02; B21D 5/00

(52) U.S. Cl. CPC B21D 5/0209; B21D 5/004

(57) ABSTRACT

A controller of a press device causes a presser to stop pressing upon a press die being displaced by a specific dimension after a time point when a detection value provided by a pressing force detector has exceeded a threshold value.

### CROSS-REFERENCE TO RELATED APPLICATIONS

This application claims the benefit of Japanese Patent Application No. 2023-096249 filed on Jun. 12, 2023 with the Japan Patent Office, the disclosure of which is incorporated herein by reference in its entirety.

### BACKGROUND

The present application relates to an invention to perform bending of a recliner ring.

For example, the invention disclosed in Japanese Unexamined Patent Application Publication No. 2019-201895 (JP2019-201895) subjects a recliner ring to plastic deformation such that a bent part having a ring shape is formed so as to prevent fall off of a ratchet, and generates a gap between the bent part and the ratchet by taking advantage of springback occurred upon the plastic deformation, to thereby avoid occurrence of interference between the bent part and the ratchet.

### SUMMARY

However, due to variations in sizes of components, characteristics of materials of the components, and the like, there may be a case where a proper gap is not generated between the bent part and the ratchet. In view of the foregoing, the present disclosure provides one example of a press device and a method of pressing.

Preferably, the press device configured to perform bending of a recliner ring comprises, for example, at least one of constituent elements to be described below.

Specifically, the constituent elements comprise: a punch configured to press the recliner ring; a punch holder holding the punch in a displaceable manner in directions along a pressing direction of the punch; a damper configured to exert an elastic force that presses the punch in the pressing direction of the punch; a press die to which the damper and the punch holder are fixed; a presser configured to press the press die in the pressing direction; a controller configured to control an operation of the presser; and a pressing force detector configured to detect a pressing force to be applied to the recliner ring by the punch. The controller causes the presser to stop pressing upon the press die being displaced by a specific dimension after a time point when a detection value provided by the pressing force detector has exceeded a specific value.

Furthermore, in a method of pressing for bending a recliner ring, it is preferable that pressing by a presser is stopped upon a press die being displaced by a specific dimension after a time point when a detection value provided by a pressing force detector has exceeded a specific value.

Consequently, the press device and the method of pressing can be expected to cause a proper springback for the reason that pressing by the presser is stopped upon the press die being displaced by the specific dimension after the time point when the detection value provided by the pressing force detector has exceeded the specific value. Therefore, a gap can be provided between a bent part and a ratchet, and the gap can suppress interference between the bent part and the ratchet.

### BRIEF DESCRIPTION OF THE DRAWINGS

Embodiments of the present disclosure will be described hereinafter with reference to the accompanying drawings, in which:

FIG. 1 is an exploded view of a recliner according to a first embodiment;

FIG. 2 is a diagram illustrating a configuration of the recliner according to the first embodiment;

FIG. 3 is a diagram illustrating the configuration of the recliner according to the first embodiment;

FIG. 4 is a diagram illustrating a press device according to the first embodiment;

FIG. 5 is a diagram illustrating the press device according to the first embodiment;

FIG. 6 is a diagram illustrating the press device according to the first embodiment; and

FIG. 7 is a graph showing a pressing force (resistance force) and a displacement quantity (displacement distance) of a press die 140.

### DETAILED DESCRIPTION OF EXEMPLARY EMBODIMENTS

Embodiments of the invention below show examples of embodiments within the technical scope of the present disclosure. In other words, invention-specifying matters and so on recited in the appended claims are not limited by specific configurations, structures, or the like indicated in the below-described embodiments.

The present embodiments are examples in which a press device and a method of pressing according to the present disclosure are applied to a recliner used in a seat mounted in a vehicle such as a car (hereinafter, referred to as “vehicle seat”). Arrows indicating directions, hatched lines, and so on shown in the drawings are provided for the purpose of easier understanding of mutual relationships between the drawings, shapes of members or portions, and so on.

A member or portion described at least with a reference numeral is at least one in number except in a case of being accompanied by restrictive words such as “only one”. The press device disclosed in the present disclosure comprises at least one of a constituent element such as a member or a portion described at least with a reference numeral or a structural part illustrated.

### First Embodiment

### <1. Overview of Recliner>

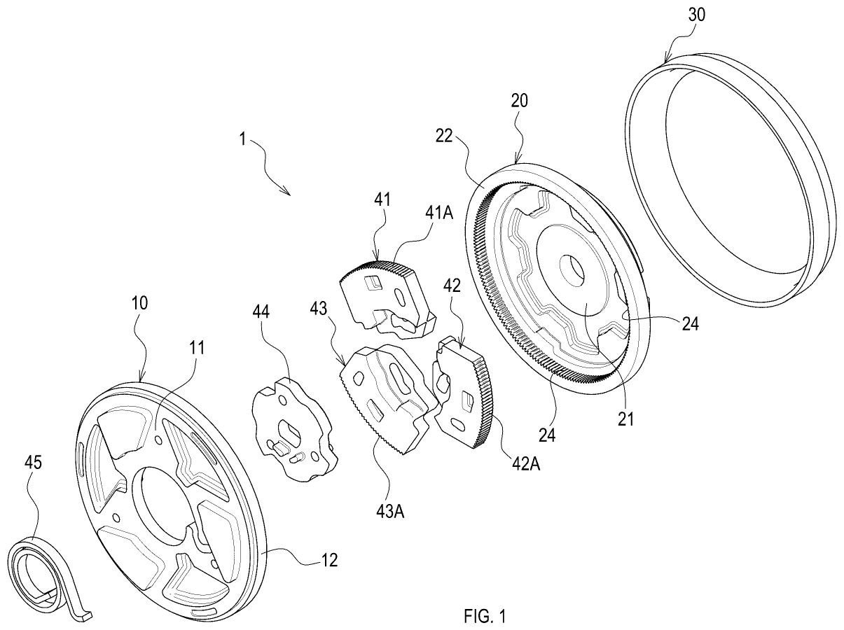

As illustrated in FIG. 1, a recliner 1 comprises, for example, at least a guide member 10, a ratchet 20, an outer circumferential ring 30, and pawls 41 to 43. That is, the recliner 1 has the same general configuration as that of the invention disclosed in JP2019-201895.

### <Guide Member>

The guide member 10 is a member fixed to a cushion frame (not shown). The cushion frame is a member forming a framework of a seat cushion. The seat cushion is a part of the vehicle seat supporting the buttocks of an occupant.

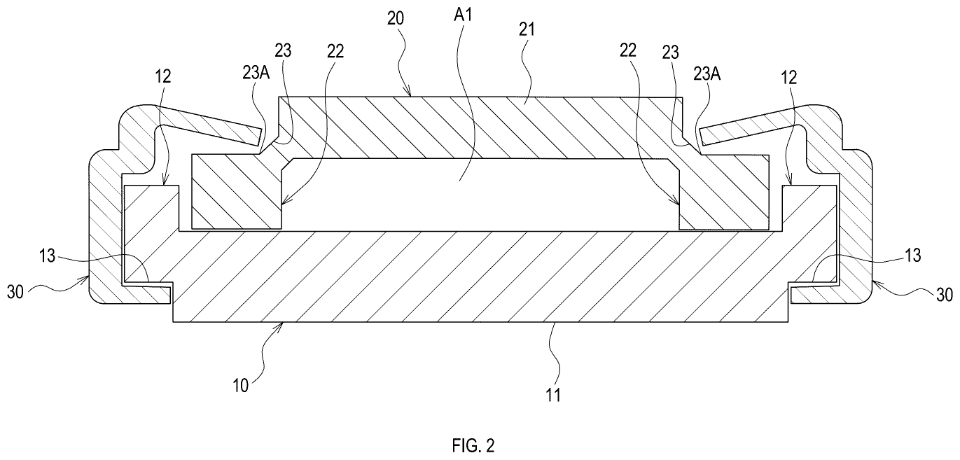

As illustrated in FIG. 2, the guide member 10 is a plate member including a first plate 11 having a round disk shape and a first flange 12. The first flange 12 is a protrusion extending from an outer edge of the first plate 11 in a direction orthogonal to the first plate 11.

The first flange 12 is formed integrally with the first plate 11 by subjecting a metal plate to a plastic deformation process such as pressing. It should be noted that a part of the outer edge of the first plate 11 corresponding to the first flange 12 is provided with a step part 13 recessed toward the first flange 12.

### <Ratchet>

The ratchet 20 is a member fixed to a back frame (not shown). The back frame is a member forming a framework of a seatback. The seatback is a part of the vehicle seat supporting the back of the occupant.

The ratchet 20 is a plate member including a second plate 21 having a round disc shape and a second flange 22. The second plate 21 is arranged opposite to the first plate 11 across a space A1.

As illustrated in FIG. 1, the second flange 22 is a protrusion extending from an entire outer edge of the second plate 21 toward the first plate 11. The second flange 22 is formed integrally with the second plate 21 by subjecting a metal plate to a plastic deformation process such as pressing.

As illustrated in FIG. 2, there is provided a tapered part 23 in a boundary between the second flange 22 and the second plate 21. The tapered part 23 is arranged in a part of the boundary opposite to the space A1, that is, at an outer side of the boundary.

The tapered part 23 is a conically tapered part that tilts so as to be closer to the first plate 11 as approaching an outer side in a radial direction of the ratchet 20. It should be noted that the tapered part 23 has an outer edge 23A located at an outermost of the tapered part 23 in the radial direction.

As illustrated in FIG. 1, an inner circumferential surface of the second flange 22 is provided with a serrated part 24 that is engaged with serrated parts 41A to 43A. The serrated parts 41A to 43A, respectively, are provided in the pawls 41 to 43.

The pawls 41 to 43 are accommodated inside the space A1 that is interposed between the guide member 10 and the ratchet 20. The pawls 41 to 43 can be displaced such that the pawls 41 to 43 can contact and be separated from the second flange 22. In a state where the serrated parts 41A to 43A are engaged with the serrated part 24, the guide member 10 is placed in a non-rotatable state with respect to the ratchet 20.

### <Outer Circumferential Ring and Other Components>

The outer circumferential ring 30 is one example of the recliner ring, and couples the guide member 10 and the ratchet 20.

Specifically, the outer circumferential ring 30 restricts separation of the guide member 10 from the ratchet 20 while allowing the guide member 10 to rotate relative to the ratchet 20.

A hinge cam 44 is a member to displace the pawls 41 to 43. Upon the hinge cam 44 rotating by externally receiving an operation force, the hinge cam 44 separates the serrated parts 41A to 43A of the pawl 41 to 43 from the serrated part 24.

Upon elimination of the operation force, the pawls 41 to 43 are displaced by an elastic force of a spiral spring 45 to a position where the serrated parts 41A to 43A are fitted in the serrated part 24, and thereafter held at this position by the elastic force.

### <2. Details of Outer Circumferential Ring>

### <2.1 Configuration of Outer Circumferential Ring>

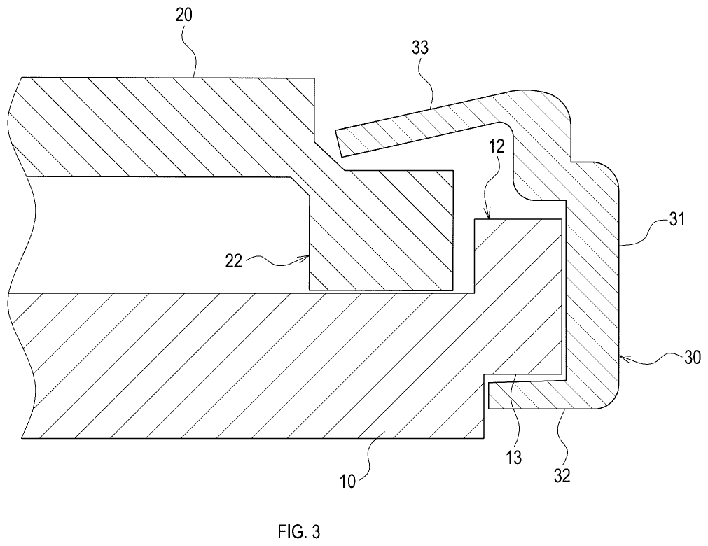

As illustrated in FIG. 3, the outer circumferential ring 30 includes a ring body 31 having an annular shape, a first ring flange 32, and a second ring flange 33. The outer circumferential ring 30 is formed into a substantially U-shape or a square U-shape in a cross-section so as to hold the guide member 10 and the ratchet 20.

Specifically, the first ring flange 32 and the second ring flange 33 are parts extending from the ring body 31 toward an inner side in a radial direction of the ring body 31. “Extending toward the inner side in the radial direction” means extension in a direction toward the center of the ring body 31 having the annular shape.

The first ring flange 32 faces an outer circumferential part of the guide member 10 (in the present embodiment, the step part 13) outside the guide member 10. The second ring flange 33 faces an outer circumferential part of the ratchet 20 (in the present embodiment, the second flange 22 and the tapered part 23) outside the ratchet 20.

It should be noted that a gap between the first ring flange 32 and the guide member 10, and a gap between the second ring flange 33 and the ratchet 20 are as minute as less than 1 mm in median dimension of design.

Therefore, the first ring flange 32 can contact an outer side of the guide member 10; and the second ring flange 33 can contact the ratchet 20. When the space interposed between the guide member 10 and the ratchet 20 is defined as “inner side”, the outer side means an opposite side to the inner side.

### <3. Method of Manufacturing Recliner (Particularly, Second Ring Flange)>

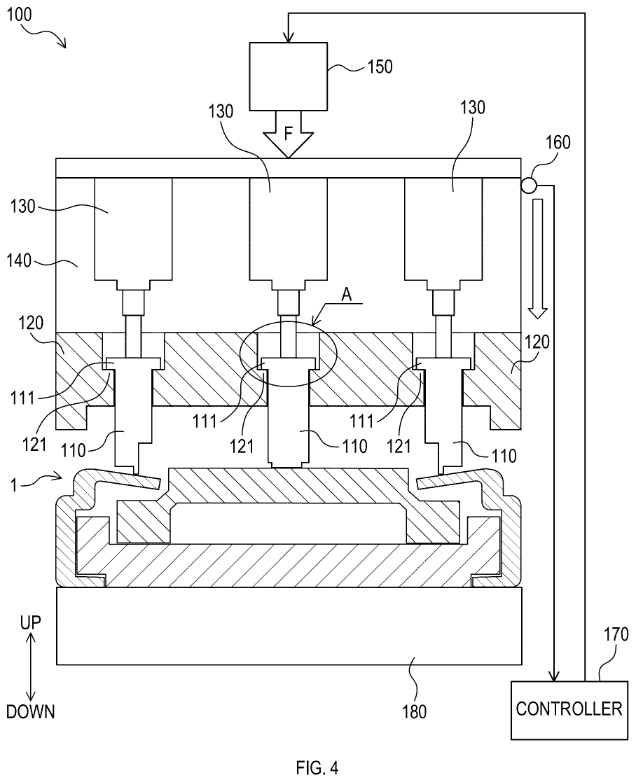

FIG. 4 illustrates a press device 100 to perform a method of pressing according to the present embodiment. Specifically, the press device 100 is a device to subject the outer circumferential ring 30 to plastic deformation to thereby form the second ring flange 33.

As illustrated in FIG. 4, the press device 100 comprises at least a punch 110, a punch holder 120, a damper 130, a press die (upper die) 140, a presser 150, a pressing force detector 160, a controller 170, and a receiving die (lower die) 180.

### <Punch>

The punch 110 is a member to press a part of the outer circumferential ring 30 corresponding to the second ring flange 33. The punch 110 plastically deforms a part of the outer circumferential ring 30 to thereby form a part extending from the ring body 31 toward the inner side in the radial direction, that is, the second ring flange 33.

It should be noted that, in the present embodiment, there are provided two or more punches 110 (in the present embodiment, three punches 110 at intervals of 120 degrees). That is, the press device 100 according to the present embodiment presses two or more parts of the outer circumferential ring 30 to thereby form the second ring flange 33.

### <Punch Holder and Damper>

The punch holder 120 is a member to hold the punch 110 in a displaceable manner in directions along a pressing direction of the punch 110 (in FIG. 4, up-down directions). The damper 130 exerts an elastic force so as to press the punch 110 in the pressing direction (in FIG. 4, a downward direction).

It should be noted that an area A in the punch holder 120 is provided with a locking portion 121 configured to be locked with a flange 111 provided to the punch 110. Consequently, the punch 110 is not further displaced in the pressing direction (in FIG. 4, the downward direction) so as to go beyond a state where the flange 111 is locked with the locking portion 121.

Furthermore, an upper part of the punch holder 120, that is, an opposite side thereof to the locking portion 121, is closed by the press die 140. Consequently, the punch 110 is not displaced in an opposite direction to the pressing direction beyond an upper end surface of the punch holder 120.

### <Press Die and Presser>

The press die 140 is an upper die to which the damper 130 and the punch holder 120 are fixed, with rigidity to the extent that the press die 140 can be regarded as a rigid body. The presser 150 is a press machine to press the press die 140 in the pressing direction.

The presser 150 according to the present embodiment is a servo press machine employing a servomotor and a ball screw. It should be noted that the pressing force acting on the outer circumferential ring 30 via the punch 110 is received by the receiving die 180, which is a lower die.

### <Pressing Force Detector>

The pressing force detector 160 detects the pressing force to be applied by the punch 110 to the outer circumferential ring 30, which is one example of the recliner ring 30, that is, a pressing force to be generated by the presser 150. A detection signal of the pressing force detector 160 is input to the controller 170.

### <Controller>

The controller 170 is a controller to control an operation of the presser 150. The controller 170 is a microcontroller including a CPU, a ROM, a RAM and the like. It should be noted that a software to control the operation of the presser 150 is stored in a non-volatile memory such as the ROM.

After the punch 110 starts pressing the part of the outer circumferential ring 30 corresponding to the second ring flange 33, the controller 170 causes the presser 150 to stop pressing upon the press die 140 being displaced by a predetermined dimension (hereinafter, referred to as “specific dimension”) after a time point when a detection value provided by the pressing force detector 160 has exceeded a specific threshold value.

### <Operation of Press Device>

In a non-operation state (hereinafter, referred to as “initial state”) of the presser 150, as illustrated in FIG. 4, the flange 111 of the punch 110 is locked with the locking portion 121. It should be noted that the damper 130 exerts a predetermined elastic force in the initial state.

Upon the press die 140 being displaced in the pressing direction as the presser 150 operates, a pressing force of the presser 150 is transmitted to the punch 110 via the damper 130. Then, the outer circumferential ring 30 is plastically deformed such that the second ring flange 33 approaches the tapered part 23.

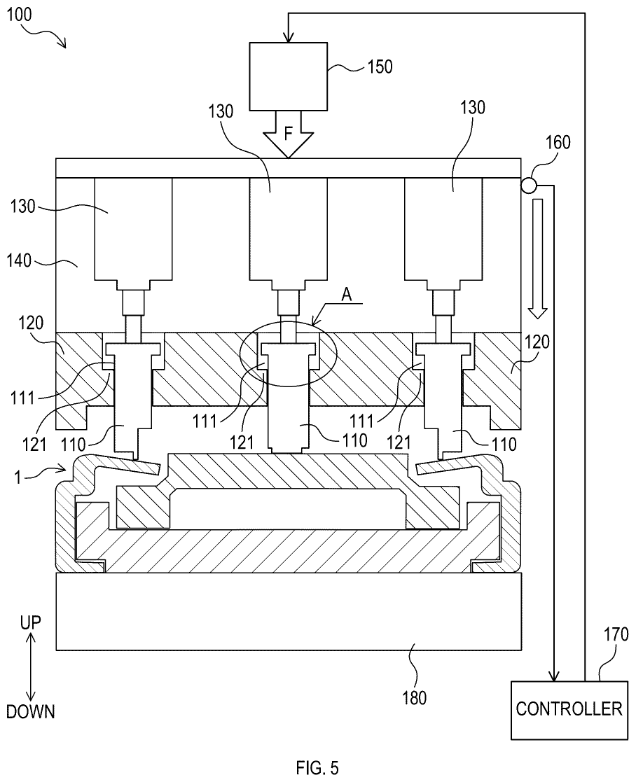

At that time, the punch 110 receives a resistance force from the second ring flange 33, that is, the outer circumferential ring 30. The resistance force makes the flange 111 separated from the locking portion 121 and increases a separation dimension accordingly (see, FIG. 5).

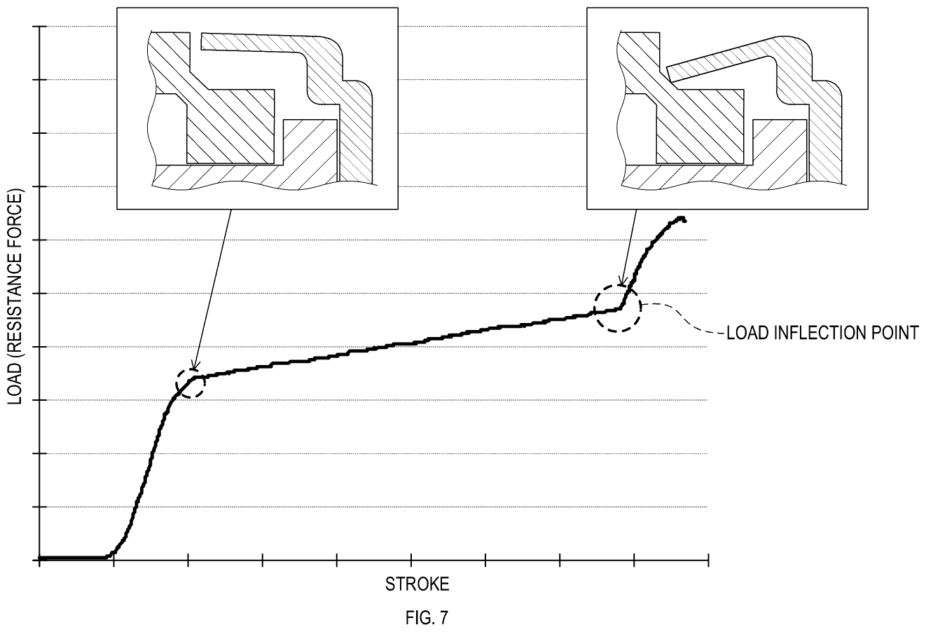

Subsequently, upon the second ring flange 33 contacting the tapered part 23, the resistance force received by the presser 150 from the outer circumferential ring 30 rapidly increases. In the present embodiment, a resistance force at a time point of its rapid increase (a load inflection point in FIG. 7) is used as the above-described threshold value. It should be noted that FIG. 7 is a graph showing the pressing force (resistance force) and a displacement quantity (displacement distance) of the press die 140.

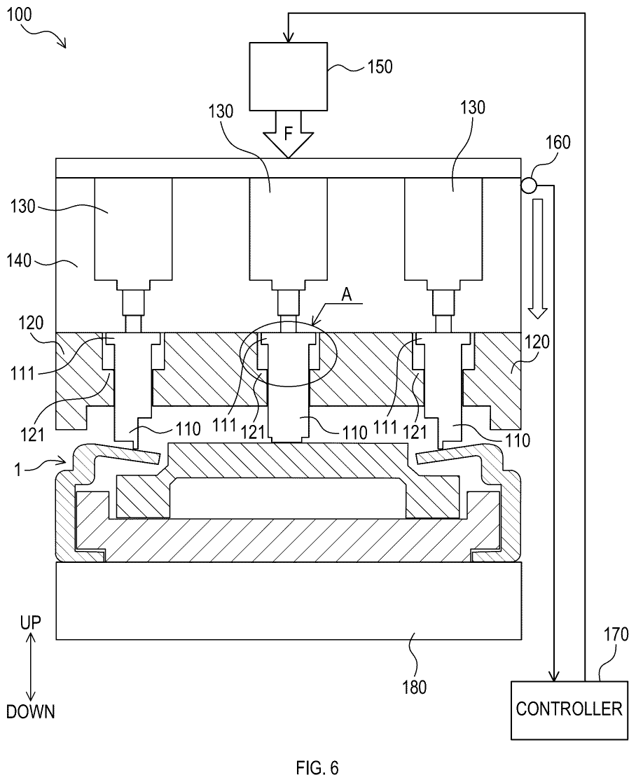

Subsequently, the controller 170 causes the presser 150 to stop pressing upon the press die 140 being displaced by the specific dimension. It should be noted that, on and after any time point after the pressing force of the presser 150 has reached the threshold value, the punch 110 may contact the press die 140 (see, FIG. 6).

On and after the above-described time point where the state illustrated in FIG. 6 occurs, the punch 110 is displaced integrally with the press die 140 in practice. That is, on and after this time point, a force to press the punch 110 is directly transmitted to the punch 110 not substantially via the damper 130.

As is clear from the above description on the operation, the elastic force generated by the damper 130 in the initial state is required to be as large as or larger than a magnitude that can at least cause plastic deformation of the second ring flange 33.

On and after the above-described time point, the force to press the punch 110 is directly transmitted to the punch 110 not via the damper 130. Accordingly, the elastic force generated by the damper 130 does not increase in practice.

### <Features of Press Device and Method of Pressing According to Present Embodiment>

The press device 100 and the method of pressing cause the presser 150 to stop pressing upon the press die 140 being displaced by the specific dimension after a time point when the detection value provided by pressing force detector 160 has exceeded the threshold value. Consequently, a proper springback is expected to occur in the second ring flange 33.

In other words, the controller 170 causes the punch 110 to simply press and plastically deform the outer circumferential ring 30 until the detection value exceeds the threshold value, that is, until the second ring flange 33 contacts the tapered part 23 and whereby the resistance force rapidly increases.

That “the second ring flange 33 contacts the tapered part 23 and whereby the resistance force rapidly increases” is under no influence of size variations and the like among components. In other words, there is no influence of size variations and the like among the components over the time point when “the detection value provided by the pressing force detector 160 has exceeded the threshold value”.

Thus, when the presser 150 is operated to stop pressing upon the press die 140 being displaced by the specific dimension after the time point when the detection value has exceeded the threshold value, there can be provided a proper gap between the second ring flange 33 and the ratchet 20. Accordingly, occurrence of interference can be inhibited between the second ring flange 33 the ratchet 20.

### Other Embodiments

In the above-described embodiment, the resistance force at the time point of its rapid increase (the load inflection point in FIG. 7) is used as the above-described threshold value. However, the present disclosure is not limited hereto. Specifically, the present disclosure may have a configuration of, for example, using a value obtained by adding/deducting a specific load to/from a load at the load inflection point as the above-described threshold value.

Furthermore, the present disclosure only has to be consistent with ideas of the present disclosure provided in the above-described embodiments, and is not limited to the above-described embodiments. Therefore, the present disclosure may be configured in combination of at least two embodiments of the above-described embodiments or may be configured so as to eliminate any of the illustrated constituent elements or the constituent elements described with reference numerals in the above-described embodiments.

What is claimed is:

1. A press device configured to perform bending of a recliner ring, the press device comprising:
a punch configured to press the recliner ring;
a punch holder holding the punch in a displaceable manner in directions along a pressing direction of the punch;
a damper configured to exert an elastic force that presses the punch in the pressing direction of the punch;
a press die to which the damper and the punch holder are fixed;
a presser configured to press the press die in the pressing direction;
a controller configured to control an operation of the presser; and
a pressing force detector configured to detect a pressing force to be applied to the recliner ring by the punch,
the controller configured to cause the presser to stop pressing upon the press die being displaced by a specific dimension after a time point when a detection value provided by the pressing force detector has exceeded a specific value.

2. A method of pressing for bending a recliner ring, the method comprising:
using a press device including:
a punch configured to press the recliner ring;
a punch holder holding the punch in a displaceable manner in directions along a pressing direction of the punch;
a damper configured to exert an elastic force that presses the punch in the pressing direction of the punch;
a press die to which the damper and the punch holder are fixed;
a presser configured to press the press die in the pressing direction; and
a pressing force detector configured to detect a pressing force to be applied to the recliner ring by the punch; and
causing the presser to stop pressing upon the press die being displaced by a specific dimension after a time point when a detection value provided by the pressing force detector has exceeded a specific value.
